(19) United States
(12) Patent Application Publication
(10) Pub. No.: US 2023/0270300 A1
(43) Pub. Date: Aug. 31, 2023

(54) NOZZLE UNIT AND ROBOT CLEANER INCLUDING SAME

(71) Applicant: LG ELECTRONICS INC., Seoul (KR)

(72) Inventors: Changhwa SUN, Seoul (KR); Seungyeop LEE, Seoul (KR); Sangchul LEE, Seoul (KR); Jungmin KO, Seoul (KR)

(21) Appl. No.: 18/017,478

(22) PCT Filed: Dec. 7, 2020
(86) PCT No.: PCT/KR2020/017729

§ 371 Date: Jan. 23, 2023

(30) Foreign Application Priority Data
Jul. 23, 2020 (KR) 10-2020-0091868

(51) Int. Cl. A47L 9/04; A47L 7/00; A47L 9/28; B08B 1/00

(52) U.S. Cl. CPC A47L 9/0477; A47L 7/0066; A47L 9/0433; A47L 9/0488; A47L 9/2852; B08B 1/007; A47L 2201/00

(57) ABSTRACT

Disclosed are a nozzle unit and a robot cleaner including same. The nozzle unit according to various embodiments of the present invention comprises a main brush for collecting waste such as hair and a sub brush for separating the waste such as hair attached to the main brush. The sub brush is provided with various members according to the embodiment, and separates the waste such as hair attached to the main brush. Thus, the waste such as hair can be easily collected, separated, and captured. Accordingly, user convenience can be enhanced.

### TECHNICAL FIELD

The present disclosure relates to a nozzle part and a robot cleaner including the same, and more specifically, to a nozzle part having a structure capable of effectively collecting substances such as hair or fiber that is easily adhered but is not easily separated, and a robot cleaner including the same.

### BACKGROUND ART

A robot cleaner refers to a device capable of independently performing a cleaning operation according to a preset method, without requiring a user's manual operation. The robot cleaner may have an operation time and an operation method set in advance.

The robot cleaner provides various conveniences such as that the user does not need to directly perform cleaning, and that the operation mode and operation time can be arbitrarily set. Accordingly, in recent years, the demand for a robot cleaner has been increased.

The robot cleaner drives indoors according to a preset method and sucks dust, small trash or the like existing on the floor. To this end, the robot cleaner includes a motor that forms suction power, a dust bin that stores sucked dust or small trash, and a filter that purifies and discharges air sucked in the dust bin.

The trash collected by the robot cleaner may have many forms. For example, the trash may include hair that has been removed from a human body, fiber strands separated from clothes, and the like.

With the trend of decreasing the number of members constituting households, such as single-person households, households with companion animals are increasing. In the above case, by the way, companion animals have more fur that falls out more easily than humans.

The above-described trash such as hair, fiber strands, or companion animal hair has a property of being easily adhered to an object having a rough surface by electrostatic attraction. At the same time, the trash has a property of not being easily separated from a surface of the adhered object.

Therefore, in everyday life, when the trash adheres to a surface of an object made of a fibrous material such as a carpet or a rug, it is not easy to separate it. Even when the trash is collected while the housework and robot cleaner drives on a surface such as a carpet or a rug, it is difficult to separate the trash from the robot cleaner.

Accordingly, not only the user's convenience is deteriorated, but there is also a concern that the robot cleaner may malfunction or be damaged by the trash adhered to the robot cleaner.

Korean Patent Document No. 10-1981827 discloses a cleaning device for a nozzle of a vacuum cleaner. More specifically, it discloses a cleaning device for a nozzle of a vacuum cleaner including a socket for accommodating a vacuum cleaner nozzle, and a cleaning member disposed in the socket to remove articles entangled therewith while a rotatable member rotates.

However, the cleaning device for the nozzle of this type of vacuum cleaner is disposed in a charging stand for charging the vacuum cleaner. Accordingly, there is an inconvenience in that the user must place the vacuum cleaner on the charging stand and then operate the vacuum cleaner again after completing the use of the vacuum cleaner.

Korean Patent Publication No. 10-2020-0028580 discloses a pet comb capable of sucking and removing hair and a vacuum cleaner including the same. Specifically, it discloses a pet comb including a roll comb part that combs the fur of a pet inside a body case and a rake part that removes fur stuck in the roll comb portion and a vacuum cleaner including the same.

However, this type of pet comb and a vacuum cleaner including the same have a limitation in that they are applicable only to a handy type cleaner other than a robot cleaner or a large cleaner due to their use.

In addition, since both the roll comb part and the rake part are provided in a rake shape, there is also a limitation that it is difficult to remove hair tangled in each rake.
Korean Patent No. 10-1981827 (May 23, 2019)
Korean Patent Publication No. 10-2020-0028580 (Apr. 8, 2020)

### DISCLOSURE OF INVENTION

### Technical Problem

An aspect of the present disclosure is to provide a nozzle part having a structure capable of solving the foregoing problems, and a robot cleaner including the same.

First, an aspect of the present disclosure is to provide a nozzle part having a structure capable of easily collecting trash in the form of hair or fiber scattered indoors, and a robot cleaner including the same.

Furthermore, an aspect of the present disclosure is to provide a nozzle part having a structure capable of easily capturing the collected trash in the form of hair or fiber, and a robot cleaner including the same.

In addition, an aspect of the present disclosure is to provide a nozzle part having a structure capable of easily discharging the trash in the form of hair or fiber, and a robot cleaner including the same.

Moreover, an aspect of the present disclosure is to provide a nozzle part and a robot cleaner having a structure capable of minimizing the number of components that provide power to a member for achieving the above object.

Besides, an aspect of the present disclosure is to provide a nozzle part having a structure capable of simplifying the structure of the member for achieving the above object, and a robot cleaner including the same.

Moreover, an aspect of the present disclosure is to provide a nozzle part having a structure that is applicable to other types of robot cleaners as well as achieving the above object, and a robot cleaner including the same.

### Solution to Problem

In order to achieve the foregoing objectives, the present disclosure provides a nozzle part, including a frame; a main brush rotatably coupled to the frame to extend in one direction; and a sub-brush located adjacent to the brush to extend in said one direction, and rotatably coupled to the frame with respect to the brush, wherein the main brush includes an adhesive member that surrounds an outer circumference of the main brush, to which trash such as fur is adhered, and the sub-brush is located at a downstream side of the rotation direction of the main brush, and the adhered trash such as fur is adhered to the adhesive member and then moved by a predetermined distance in an outer circumferential direction of the main brush, and then brought into contact with the sub-brush, and the main brush and the sub-brush are rotated in opposite directions.

Furthermore, the sub-brush may define an outer circumference of the sub-brush, and may include a sub-outer circumferential surface disposed to have a roughness smaller than that of the adhesive member.

Furthermore, a plurality of the-sub brushes may be provided, and the plurality of sub-brushes may be located adjacent to each other, and the adhered trash such as fur may be separated from the adhesive member while passing between the plurality of sub-brushes.

Furthermore, the sub-brush may include a protrusion member disposed to protrude from an outer circumferential surface of the sub-brush to separate the adhered trash such as fur from the adhesive member.

Furthermore, a plurality of the protrusion members may be defined, and the plurality of the protrusion members may be spaced apart from each other and arranged in parallel along said one direction, and a plurality of rows defined by arranging the plurality of the protrusion members in parallel along said one direction may be spaced apart from each other along a circumferential direction of the sub-brush.

Furthermore, for the respective rows located adjacent to each other among the rows defined by the plurality of protrusion members, the protrusion members and spaces in which the protruding members are spaced apart from each other may be alternately arranged along a circumferential direction of the sub-brush.

Furthermore, a plurality of the sub-brushes may be provided, and the plurality of the sub-brushes may be located adjacent to each other, and the protrusion member disposed on any one of the plurality of the sub-brushes may be inserted into a space in which the protrusion members adjacent to another one of the plurality of sub-brushes are spaced apart from each other.

Furthermore, a cross-sectional area of the protrusion member may be defined to be reduced in a direction opposite to the outer circumferential surface of the sub-brush.

Furthermore, the sub-brush may include a plurality of blade members extending in said one direction, radially inward end portions of which are coupled to each other, and radially outward end portions of which are exposed to the outside.

Furthermore, the blade member may include at least one curved portion along said one direction.

Furthermore, the nozzle part may include a main gear coupled to the main brush to rotate together with the main brush; and a sub-gear coupled to the sub-brush, and gear-fitted to the main gear.

Furthermore, the main gear and the sub-gear may include a teeth part in which a plurality of convex portions and concave portions are alternately arranged along an outer circumference thereof, and the teeth part of the main gear may include a larger number of convex portions and concave portions than that of the teeth part of the sub-gear.

In addition, the present disclosure provides a robot cleaner, including a body part; a dust bin detachably coupled to the body part, and defined with a space therein; a nozzle housing detachably coupled to the body part, an inner space of which communicates with the space of the dust bin; and a nozzle part rotatably accommodated in the nozzle housing, and partially exposed to an outside of the nozzle housing, wherein the nozzle part includes a frame coupled to the nozzle housing; a main brush rotatably coupled to the frame to extend in one direction; and a sub-brush located adjacent to the brush to extend in said one direction, and rotatably coupled to the frame with respect to the brush, and wherein the main brush includes an adhesive member that surrounds an outer circumference of the main brush, to which trash such as fur is adhered, and the sub-brush is located at a downstream side of the rotation direction of the main brush, and the adhered trash such as fur is adhered to the adhesive member and then moved by a predetermined distance in an outer circumferential direction of the main brush, and then brought into contact with the sub-brush, and the main brush and the sub-brush are rotated in opposite directions.

Furthermore, the nozzle part of the robot cleaner may include a main gear coupled to the main brush to rotate together with the main brush; a sub-gear coupled to the sub-brush, and rotated together with the sub-brush, and gear-coupled to the main gear; and a power part connected to the main brush, and rotated to rotate the main brush, wherein the number of concave portions and convex portions arranged in the main gear are defined to be greater than that of concave portions and convex portions arranged in the sub-gear, and the sub-brush is rotated at a faster speed than the main brush when the power part is rotated.

Furthermore, the sub-brush in the nozzle part of the robot cleaner may include a sub-outer circumference defining an outer circumference of the sub-brush, and having a smaller roughness than the adhesive member, and a plurality of the sub-brushes may be provided, and the plurality of the sub-brushes may be located adjacent to each other, and the adhered trash such as fur may be separated from the adhesive member while passing between the plurality of sub-brushes.

Furthermore, the nozzle part of the robot cleaner may include a protrusion member disposed to protrude from an outer circumferential surface of the sub-brush to separate the adhered trash such as fur from the adhesive member, wherein a plurality of the protrusion members are defined, and the plurality of the protrusion members are spaced apart from each other and arranged in parallel along said one direction, and a plurality of rows defined by arranging the plurality of the protrusion members in parallel along said one direction are spaced apart from each other along a circumferential direction of the sub-brush.

The nozzle part of the robot cleaner may include a plurality of blade members extending in said one direction, radially inward end portions of which are coupled to each other, and radially outward end portions of which are exposed to the outside, wherein the blade members includes at least one curved portion along said one direction.

### Advantageous Effects of Invention

According to an embodiment of the present disclosure, the following effects may be achieved.

First, a main brush is provided in a nozzle part. The main brush is extended in one direction, and an adhesive member formed of a material such as felt having a high roughness is provided on an outer circumference thereof. In other words, the adhesive member constitutes an outer circumferential surface of the main brush. The main brush is partially exposed to an outside of a nozzle housing.

When the robot cleaner is operated, the adhesive member rolls along a floor surface to be cleaned. Due to the material of the adhesive member and the characteristics of its shape, trash such as fur staying on the floor surface is easily adhered to the adhesive member.

Accordingly, trash such as fur existing in a region where the robot cleaner has passed while being driven may be easily collected.

Furthermore, the nozzle part according to various embodiments is provided with a member for separating trash such as fur adhered thereto. The nozzle part is provided with a sub-brush that rotates at a higher speed in a direction opposite to the main brush provided with the adhesive member.

In one embodiment, a sub-outer circumferential surface having a roughness smaller than that of the adhesive member is defined on the sub-brush. Trash such as fur adhered to the adhesive member is pressed by the sub-outer circumferential surface and separated from the adhesive member.

In another embodiment, the sub-brush is provided with a protrusion member protruding from an outer circumferential surface thereof. Trash such as fur adhered to the adhesive member is caught by the protrusion member and separated from the adhesive member.

In still another embodiment, the sub-brush is provided with a blade member. Trash such as fur adhered to the adhesive member is swept by the blade member and separated from the adhesive member.

Accordingly, the collected trash such as fur may be easily collected in a dust bin through an inner space of the nozzle housing and body part without any additional operation.

Furthermore, the dust bin is detachably coupled to the body part. An inner space of the dust bin communicates with an inner space of the body part. Through the foregoing process, trash such as fur scattered on the floor surface is collected and then moved and accommodated in the dust bin.

Accordingly, a user may separate only the dust bin to easily discharge the collected trash such as fur.

In addition, the main gear is coupled to the main brush. The main gear is gear-coupled to the sub-gear located at a radial outer side of the brush. The sub-gear is coupled to the sub brush.

When a power part is operated, the main brush and the main gear rotate together. The sub-gear coupled to the sub-gear and the sub-brush is also rotated.

Therefore, when the main brush is rotated by a single power part, the sub-brush located adjacent to the main brush may also be rotated. Accordingly, the number of power sources required to rotate the main brush and the sub-brush may be minimized.

Moreover, through the foregoing configuration, the main brush and the sub-brush may be rotated simultaneously by a single power part. Accordingly, the configuration of the nozzle part may be defined simply.

In addition, the nozzle housing accommodating the nozzle part is detachably coupled to the body part. Therefore, the foregoing effects may be achieved only by separating the nozzle housing from the body part and coupling it to the body part of another robot cleaner.

Accordingly, the versatility of the nozzle part may be improved. In addition, the user may purchase only the nozzle part separately without purchasing an entire robot cleaner to use it for the robot cleaner previously used. As a result, user convenience and economy may be improved.

### BRIEF DESCRIPTION OF DRAWINGS

FIG. 1 is a perspective view illustrating a robot cleaner according to an embodiment of the present disclosure.

FIG. 2 is a perspective view illustrating a nozzle housing provided in the robot cleaner of FIG. 1.

FIG. 3 is a perspective view illustrating a nozzle part according to an embodiment of the present disclosure that is accommodated in the nozzle housing of FIG. 2.

FIG. 4 is a bottom view illustrating the nozzle part of FIG. 3.

FIG. 5 is a rear view illustrating the nozzle part of FIG. 3.

FIG. 6 is a perspective view illustrating the nozzle part of FIG. 3 from another angle.

FIG. 7 is a perspective view illustrating a nozzle part according to a modified example of the embodiment illustrated in FIG. 3.

FIG. 8 is a perspective view illustrating the nozzle part of FIG. 7 from another angle.

FIG. 9 is a perspective view illustrating a nozzle part according to another embodiment of the present disclosure that is accommodated in the nozzle housing of FIG. 2.

FIG. 10 is a perspective view illustrating a nozzle part according to a modified example of the embodiment illustrated in FIG. 9.

FIG. 11 is a perspective view illustrating a nozzle part according to still another embodiment of the present disclosure that is accommodated in the nozzle housing of FIG. 2.

FIG. 12 is a perspective view illustrating a nozzle part according to a modified example of the embodiment illustrated in FIG. 11.

FIG. 13 is a side view illustrating an operation process of a main brush and a sub-brush provided in a nozzle part according to various embodiments of the present disclosure.

FIG. 14 is a side view illustrating an operation process of a main brush and a sub brush provided in a nozzle part according to each modified example in various embodiments of the present disclosure.

FIG. 15 is a conceptual view illustrating a process of collecting trash such as fur by a robot cleaner according to various embodiments of the present disclosure.

### MODE FOR THE INVENTION

Hereinafter, a nozzle part according to an embodiment of the present disclosure and a robot cleaner including the same will be described in detail with reference to the accompanying drawings.

In the following description, the description of some components may be omitted to clarify the features of the present disclosure.

### 1. Definition of Terms

In case where an element is “connected” or “linked” to the other element, it may be directly connected or linked to the other element, but it should be understood that any other element may be existed therebetween.

In contrast, when an element is referred to as being “directly connected with” another element, there are no intervening elements present.

Unless clearly used otherwise, a singular expression used in the present disclosure may include a plural expression.

The term “dust” used in the following description refers to fine-sized particles, dust, etc. existing in an environment such as indoors where a robot cleaner is operated.

The term “small trash” used in the following description refers to trash of a size that is larger than dust but can be collected by the robot cleaner.

The term “fur” used in the following description refers to a fine thread-like material that has been removed from animals, including humans. The fur may be body hair that has been removed from a human body, hair on the head, or body hair that has been removed from an animal body.

The term “fiber” used in the following description refers to any fine thread-like material except for the fur. In one embodiment, the fiber may be a material that has been removed from clothing, bedding, furniture, and miscellaneous goods.

In the following description, hair and fiber are collectively referred to as “fur (F) or the like.”

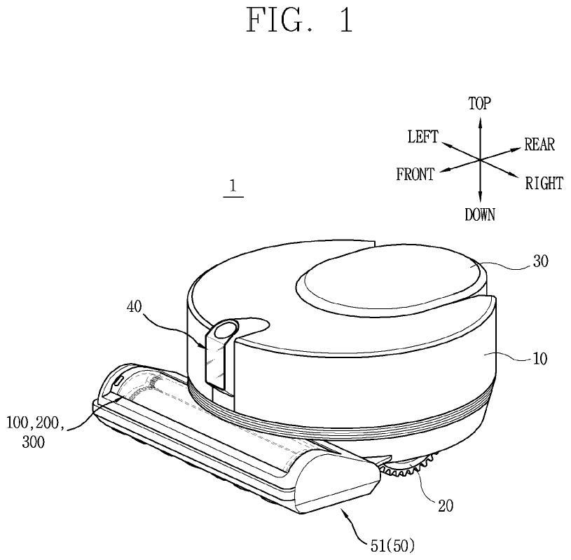

The terms “front side”, “rear side”, “left side”, “right side”, “top side” and “bottom side” used in the following description will be understood with reference to a coordinate system illustrated in FIG. 1.

2. Description of Configuration of Robot Cleaner 1 According to Embodiment of Present Disclosure

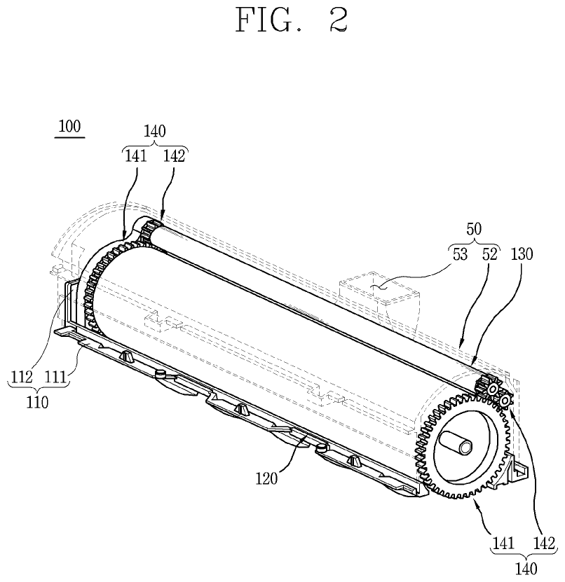

Referring to FIGS. 1 and 2, a robot cleaner 1 according to an embodiment of the present disclosure includes a body part 10, a driving part 20, a dust bin 30, a sensor part 40, a nozzle housing 50, and a nozzle part 100, 200, 300.

Hereinafter, each configuration of the robot cleaner 1 according to an embodiment of the present disclosure will be described with reference to the accompanying drawings, but the nozzle part 100, 200, 300 will be described as a separate paragraph.

Description of Body Part 10

The body part 10 forms an outer shape of the robot cleaner 1. The body part 10 may accommodate components for the robot cleaner 1 to perform a cleaning operation in a space accommodated therein.

The body part 10 may collide with various obstacles provided in a region where the robot cleaner 1 is driven, for example, indoors. Therefore, the body part 10 is preferably formed of a material of high rigidity to prevent damage due to a collision.

In addition, the body part 10 is preferably formed of a lightweight material. This is to reduce power required for the driving of the robot cleaner 1.

In one embodiment, the body part 10 may be formed of a synthetic resin such as reinforced plastic.

A user interface may be provided outside the body part 10. The user may manipulate the user interface to control the operation of the robot cleaner 1. Furthermore, the user interface may display information on the robot cleaner 1 and the state of a region where the robot cleaner 1 is driven.

An inner space of the body part 10 may communicate with the outside. Air or small trash collected while the robot cleaner 1 is driven may flow into the dust bin 30 that is detachably coupled through an inner space of the body part 10. In addition, air introduced together with dust or small trash may be discharged to an outside of the body part 10.

Various sensors may be provided in the body part 10. In other words, in addition to the sensor part 40 which will be described later, the body part 10 may be provided with a gyro sensor or the like for sensing an inclination of the floor surface (G).

In the illustrated embodiment, the body part 10 has a circular cross section, and is provided in a disk shape having a predetermined height in a vertical direction. Accordingly, when the robot cleaner 1 collides with various obstacles while being driven, the body part 10 may rotate and drive in various directions.

A nozzle housing 50 and a nozzle part 100, 200, 300 accommodated in the nozzle housing 50 are detachably coupled to the body part 10. An inner space of the nozzle housing 50 may communicate with an inner space of the body part 10 and the dust bin 30.

Accordingly, trash (H) such as fur collected by the nozzle part 100, 200, 300 may be introduced and collected in the dust bin 30 through an inner space of the body part 10.

The driving part 20 is rotatably coupled to a lower side of the body part 10.

The driving part 20 provides power for moving the robot cleaner 1. In addition, the driving part 20 allows the robot cleaner 1 to be rotated to change the driving direction.

The driving part 20 is located at a lower side of the robot cleaner 1. The driving part 20 is rotatably coupled to a lower side of the body part 10.

The driving part 20 may be provided in a form capable of being rotated to move forward or backward. In the illustrated embodiment, the driving part 20 is provided in the form of a wheel.

A plurality of driving parts 20 may be provided. In the illustrated embodiment, the driving part 20 is provided on the left and right sides, respectively, at a lower side of the body part 10. The rotational speed and rotation direction of each driving part 20 positioned on each side may be controlled independently of each other.

Accordingly, the robot cleaner 1 may move forward, backward, rotate left or right.

Although not shown, the driving part 20 may be coupled to a power device (not shown). The power device (not shown) may be provided in the form of a motor that rotates the driving part 20 by receiving an electric signal.

In one embodiment, a plurality of power devices (not shown) may be provided, and coupled to a plurality of driving parts 20, respectively. Accordingly, the plurality of driving parts 20 may be controlled independently of each other.

The dust bin 30 stores the collected trash while the robot cleaner 1 is driven. In one embodiment, the dust bin 30 may accommodate trash (H) such as fur.

A predetermined space is defined inside the dust bin 30. The space communicates with a space disposed inside the body part 10. The trash collected through the nozzle part 100, 200, 300 may pass through the space disposed inside the body part 10 to enter an inside of the dust bin 30.

The dust bin 30 is detachably coupled to the body part 10. The user may release the dust bin 30 from the body part 10 to easily remove trash accommodated in the dust bin 30.

The dust bin 30 may be formed of a transparent material. This is to allow the user to visually recognize an amount of trash accommodated in the dust bin 30 and easily determine the discharge timing of trash.

Alternatively, a sensor (not shown) may be provided in the dust bin 30. In one embodiment, the sensor (not shown) may sense the mass or volume of trash accommodated in an inner space of the dust bin 30. The sensed mass or volume may be transmitted to the user in the form of visualization information or auditory information to allow the user to easily recognize the discharge timing of trash.

The sensor part 40 senses information on a path on which the robot cleaner 1 is driven.

The sensor part 40 may be located in a direction in which the robot cleaner 1 is to be driven. In the illustrated embodiment, the sensor part 40 is located at a front side of the body part 10 to sense information about an environment at a front side of the robot cleaner 1.

The sensor part 40 may be provided in an arbitrary form capable of detecting information on the environment of a path on which the robot cleaner 1 is driven or to be driven. In the illustrated embodiment, the sensor part 40 is provided as a camera capable of sensing image information.

Although not shown, the sensor part 40 may further include an infrared sensor or the like for sensing a distance to an obstacle.

The nozzle housing 50 is detachably coupled to a lower side of the sensor part 40, that is, at a lower side of the front of the body part 10.

The nozzle housing 50 accommodates the nozzle part 100, 200, 300. As the robot cleaner 1 is driven, trash collected by the nozzle part 100, 200, 300, particularly, trash (H) such as fur may be introduced into a space inside the body part 10 and the dust bin 30 through the nozzle housing 50.

The nozzle housing 50 is located at a lower side of the front of the body part 10. When the driving part 20 is rotated, a lower side of the nozzle housing 50 may be in contact with the floor surface (G) or spaced apart by a predetermined distance to move together with the body part 10.

A space is defined inside the nozzle housing 50. The nozzle part 100, 200, 300 is accommodated in the space. As will be described later, the nozzle part 100, 200, 300 includes a frame 110, 210, 310, a main brush 120, 220, 320 and a sub-brush 130, 230, 330 rotatably coupled to the frame 110, 210, 310. The brush 120, 220, 320 and the sub-brush 130, 230, 330 of the nozzle part 100, 200, 300 may be rotated in an inner space of the nozzle housing 50.

The nozzle housing 50 is detachably coupled to the body part 10. When the nozzle housing 50 and the body part 10 are coupled to each other, the inner space of the nozzle housing 50 communicates with the inner space of the body part 10. Accordingly, the inner space of the nozzle housing 50 may communicate with the dust container 30.

The nozzle housing 50 is coupled to the body part 10 and moved together, and may have any shape capable of accommodating the nozzle part 100, 200, 300 therein. In the illustrated embodiment, the nozzle housing 50 has a polygonal columnar shape that extends long in a left-right direction, and protrudes upward with different inclination angles in a front-rear direction.

The nozzle housing 50 may collide with various obstacles provided in a region where the robot cleaner 1 is driven, for example, indoors. It is because the nozzle housing 50 is coupled to the body part 10 to be exposed to an outside of the body part 10. Therefore, the nozzle housing 50 is preferably formed of a material of high rigidity to prevent damage due to a collision.

Furthermore, the nozzle housing 50 is preferably formed of a lightweight material. This is to reduce power required for the driving of the robot cleaner 1.

In one embodiment, the nozzle housing 50 may be formed of a synthetic resin such as reinforced plastic.

In the illustrated embodiment, the nozzle housing 50 includes an outer housing 51, an inner housing 52 and a communication part 53.

The outer housing 51 defines an outer side of the nozzle housing 50. The outer housing 51 is exposed to an outside of the nozzle housing 50.

A predetermined space is defined inside the outer housing 51. The inner housing 52 and the nozzle part 100, 200, 300 accommodated in the inner housing 52 are accommodated in the space. The space communicates with a space disposed inside the body part 10. The communication is achieved by the communication part 53.

The inner housing 52 is located inside the outer housing 51.

The inner housing 52 defines an inner side of the nozzle housing 50. The inner housing 52 is not exposed to the outside.

A space is defined inside the inner housing 52. The nozzle part 100, 200, 300 is accommodated in the space. The brush 120 and the sub-brush 130 of the nozzle part 100, 200, 300 may be rotated while being accommodated in the inner housing 52.

The nozzle part 52 may be coupled to the inner housing 100, 200, 300. Specifically, the frame 110 of the nozzle part 100, 200, 300 may be coupled to the inner housing 52.

An opening part is disposed at one side of the inner housing 52, at a lower side in the illustrated embodiment. The nozzle part 100, 200, 300 accommodated in the inner housing 52 may be exposed to an outer side of the inner housing 52 through the opening part. Accordingly, when the robot cleaner 1 is driven, various types of trash placed on the floor surface (G) may be collected by the nozzle part 100, 200, 300.

The space defined inside the inner housing 52 communicates with the communication part 53. Various types of trash collected by the nozzle part 100, 200, 300 may pass through the communication unit 53 to be introduced into the inner space of the body part 10 and the dust container 30.

The communication part 53 communicates an inner space of the outer housing 51 and an inner space of the inner housing 52 with an inner space of the body part 10.

The communication part 53 may be located in the outer housing 51. The communication part 53 is located on one side facing the body part 10, at upper side of the rear in the illustrated embodiment.

The communication part 53 may be detachably coupled to the body part 10. By the coupling, the nozzle housing 50 and the body part 10 may be detachably coupled to each other.

3. Description of Nozzle Part 100, 200, 300 According to Various Embodiments of Present Disclosure

Referring back to FIGS. 1 and 2, the robot cleaner 1 according to an embodiment of the present disclosure includes a nozzle part 100, 200, 300.

The nozzle part 100, 200, 300 is rotated as the robot cleaner 1 is operated to collect various types of trash located on the floor surface (G) in a region where the nozzle part 100, 200, 300 is exposed.

The nozzle part 100, 200, 300 may be moved together as the robot cleaner 1 is moved. Accordingly, the nozzle part 100, 200, 300 may collect trash in various regions.

The nozzle part 100, 200, 300 may be accommodated in the nozzle housing 50, and exposed toward the floor surface (G). When the robot cleaner 1 is driven, the nozzle part 100, 200, 300 is driven while being in contact with the floor surface (G) or being separated by a predetermined distance.

The nozzle part 100, 200, 300 may be rotated. Accordingly, various types of trash located on the floor surface (G) may be collected by the nozzle part 100, 200, 300, and collected in the dust bin 30 through the nozzle housing 50.

In this specification, the description will be made on the premise that the nozzle part 100, 200, 300 is rotated to collect trash (H) such as fur.

(1) Description of nozzle part 100 according to an embodiment of present disclosure

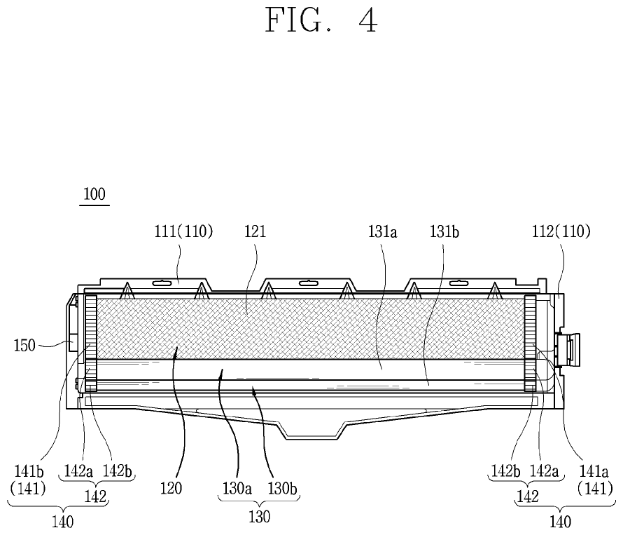

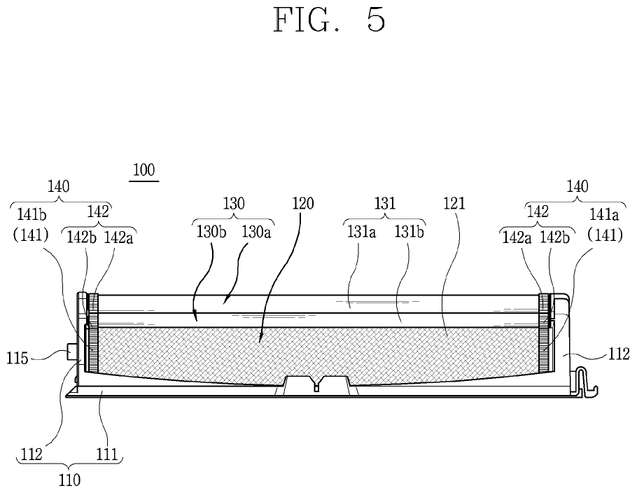

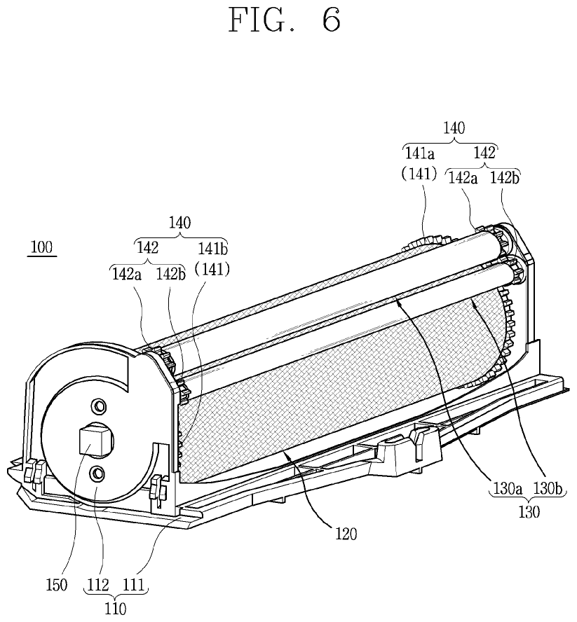

Hereinafter, a nozzle part 100 according to an embodiment of the present disclosure and a modified example thereof will be described in detail with reference to FIGS. 2 through 8.

In the illustrated embodiment, the nozzle part 100 includes a frame 110, a main brush 120, a sub-brush 130, a gear part 140, and a power part 150.

The frame 110 is a portion in which the nozzle part 100 is coupled to the nozzle housing 50. In addition, the frame 110 rotatably supports the main brush 120 and the sub-brush 130.

The frame 110 may be formed of a lightweight and high rigid material. In one embodiment, the frame 110 may be formed of a synthetic resin material such as reinforced plastic.

The frame 110 defines part of the outer shape of the nozzle part 100. In the illustrated embodiment, the frame 110 defines lower, left and right sides of the nozzle part 100.

In the illustrated embodiment, the frame 110 includes a lower frame 111, and a side frame 112.

The lower frame 111 defines a lower side of the frame 110. The lower frame 111 partially surrounds a lower side of the main brush 120.

The lower frame 111 may be defined in a shape corresponding to the shape of the main brush 120. In the illustrated embodiment, the main brush 120 has a cylindrical shape extending in a left-right direction, and the lower frame 111 may also be provided in a plate shape extending in a left-right direction.

An opening part is disposed inside the lower frame 111. The opening part may be disposed to pass through upper and lower portions of the lower frame 111. Part of the main brush 120, in the illustrated embodiment, part of the lower side may be exposed to a lower side of the lower frame 111 through the opening part. Accordingly, the main brush 120 may be exposed to an outside of the nozzle housing 50.

Side frames 112 are located at respective end portions in both directions in which the lower frame 111 extends, and at left and right end portions in the illustrated embodiment, respectively.

The side frames 112 define respective end portions in a length direction of the frame 110 and in a left-right direction in the illustrated embodiment. The side frames 112 are coupled to end portions in respective directions in which the main brush 120 extends, and to the left and right end portions, respectively, in the illustrated embodiment.

Either one of the side frames 112, the side frame 112 located on the right side in the illustrated embodiment, may have a through hole formed in the length direction. A power part 150 for rotating the gear part 140 may be coupled to the through hole to pass therethrough.

The main brush 120 and the sub-brush 130 are rotatably coupled to the side frame 112. In other words, the side frame 112 is not rotated irrespective of the rotation of the main brush 120 and the sub-brush 130.

The side frame 112 may be defined in a shape corresponding to the shape of the inner space of the nozzle housing 50. In the illustrated embodiment, the side frame 112 is provided in a plate shape in which an upper end portion thereof is defined to be rounded in a convex manner toward the upper side.

The main brush 120 is rotated to collect various types of trash staying on the floor surface (G).

The main brush 120 is rotatably coupled to the frame 110. Specifically, both end portions of the main brush 120 are rotatably supported by a plurality of side frames 112.

The main brush 120 is disposed to extend in one direction. In the illustrated embodiment, the main brush 120 is formed to extend in a left-right direction. It will be understood that the extension direction is the same as that of the nozzle housing 50.

Accordingly, when the robot cleaner 1 moves forward, an area that the main brush 120 sweeps may increase. Accordingly, the cleaning efficiency of the robot cleaner 1 may be improved.

The main brush 120 may have any shape that is rotatable between the side frames 112. In the illustrated embodiment, the main brush 120 has a circular cross section and a cylindrical shape extending in a left-right direction.

In the above embodiment, even when the rotation of the main brush 120 is advanced, a distance between the center of the cross section and the outer circumference of the main brush 120 may be kept constant to perform an efficient cleaning operation.

The sub-brush 130 is located adjacent to an outer circumference of the main brush 120. The main brush 120 may be relatively rotated with respect to the sub-brush 130. Accordingly, trash (H) such as fur collected by the main brush 120 may be separated, and the detailed description thereof will be described later.

A main gear 141 is located on an outer circumference of each end portion in a direction in which the main brush 120 extends, and on an outer circumference of each of the left and right end portions in the illustrated embodiment. The main gears 141 are gear-coupled to sub-gears 142 located adjacent to an outer circumference of the main brush 120, respectively.

Accordingly, when the power part 150 is operated to rotate the main brush 120, the main gear 141, the sub-gear 142, and the sub-brush 130 connected thereto are rotated. As a result, the main brush 120 and the sub-brush 130 may be operated by a single power part 150.

The main brush 120 may be formed of a lightweight and high rigid material. In one embodiment, the main brush 120 may be formed of a synthetic resin material such as reinforced plastic.

An adhesive member 121 is provided on an outer circumference of the main brush 120.

The adhesive member 121 defines an outer circumferential surface of the main brush 120. In other words, the adhesive member 121 is provided on the main brush 120 to surround the outer circumferential surface of the main brush 120.

The adhesive member 121 may be formed of a material having a predetermined roughness. This is to easily collect trash (H) such as fur staying on the floor surface (G) by frictional force and electrostatic attraction.

Furthermore, the adhesive member 121 may be formed of a material having a predetermined adhesive strength. This is to facilitate collection by pressing and adhering trash (H) such as fur staying on the floor surface (G).

In one embodiment, the adhesive member 121 may be formed of a fibrous material such as felt, blended fabric, linen, or bristle. Alternatively, the adhesive member 121 may be formed of a material such as rubber, latex, or acryl.

In this case, the roughness of a surface in a direction in which the adhesive member 121 is exposed to the outside, and in a direction toward a radial outer side with respect to the center of the main brush 120 in the illustrated embodiment is preferably defined to be relatively higher.

As the main brush 120 and the adhesive member 121 provided therein are rotated, trash (H) such as fur located on the floor surface (G) may adhere to the adhesive member 121. Trash (H) such as sticky fur may be rotated together with the main brush 120 and the adhesive member 121, and then separated by the sub-brush 130. The detailed description thereof will be described later.

The main brush 120 is rotated about a main rotation shaft 122. In other words, the main rotation shaft 122 is a portion in which the main brush 120 is rotatably coupled to the frame 110 (i.e., the side frame 112).

Thus, the main rotation shaft 122 may be referred to as a main support shaft.

The main rotation shaft 122 extends in a direction in which the main brush 120 extends, in a left-right direction in the illustrated embodiment. The main rotation shaft 122 may be disposed to pass through a central axis of the cross section of the main brush 120.

The power part 150 is coupled to the main rotation shaft 122. When the power part 150 rotates, the main rotation shaft 122 and the main brush 120 may rotate together.

The sub-brush 130 separates trash adhered to the adhesive member 121 of the main brush 120, particularly, trash (H) such as fur from the adhesive member 121. The separated adhesive member 121 may be removed into the inside of the nozzle housing 50, and moved and collected into the dust bin 30 through the communication part 53.

The sub-brush 130 is located adjacent to the main brush 120. In the illustrated embodiment, the sub-brush 130 is located at an upper portion of the main brush 120.

The sub-brush 130 may be defined in a shape corresponding to the shape of an outer circumference of the main brush 120. In the illustrated embodiment, the main brush 120 has a cylindrical shape having a circular cross section, and the sub-brush 130 may also be formed in a cylindrical shape having a circular cross section.

At this time, a diameter of the cross section of the sub-brush 130 may be smaller than that of the cross section of the main brush 120. Accordingly, the rotational speeds of the sub-brush 130 and the main brush 120 may be adjusted.

The sub-brush 130 is located at a radial outer side of the main brush 120.

The sub-brush 130 may extend in the same direction as the main brush 120, in a left-right direction in the illustrated embodiment. Both end portions of the sub-brush 130 in an extending direction thereof, left and right ends in the illustrated embodiment may be coupled to the side frame 112.

The sub-brush 130 may be formed of a lightweight and high rigid material. In one embodiment, the sub-brush 130 may be formed of a synthetic resin material such as reinforced plastic.

The sub-brush 130 may be rotated in a direction different from the rotation direction of the main brush 120. This is due to the fact that the sub-gear 142 coupled to the sub-brush 130 is gear-coupled to the main gear 141 coupled to the main brush 120.

Furthermore, a rotational speed of the sub-brush 130 may be faster than that of the main brush 120. Accordingly, the sub-brush 130 may quickly remove trash (H) such as fur collected by the main brush 120 from a radially outer side of the main brush 120.

Such a difference in speed is achieved by the gear part 140 which will be described later.

A plurality of sub-brushes 130 may be provided. In other words, in an embodiment illustrated in FIGS. 2 through 6, two sub-brushes 130 including a first sub-brush 130a and a second sub-brush 130b are provided.

In the above embodiment, the first sub-brush 130a may be located above the second sub-brush 130b.

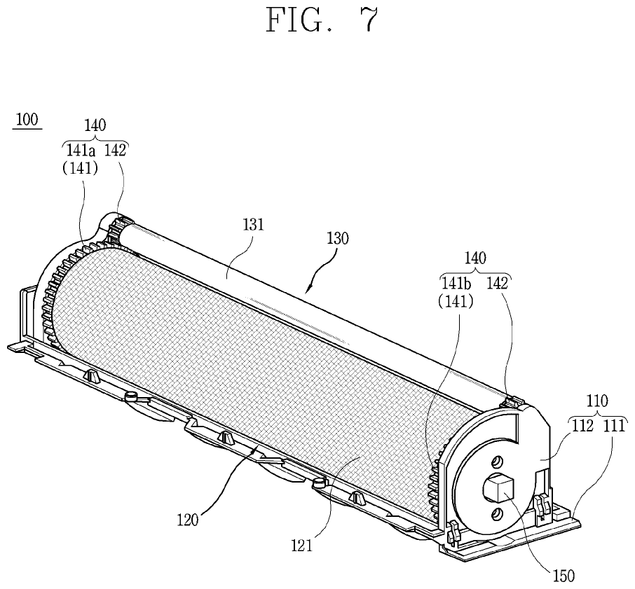

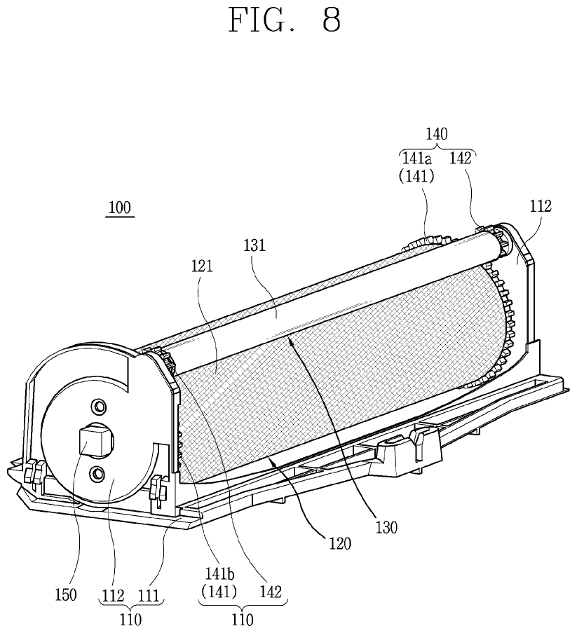

In addition, in an embodiment illustrated in FIGS. 7 and 8, a singular number of the sub-brush 130 is provided.

In the above embodiments, the sub-brush 130 is located at a downstream side of the main brush 120. Accordingly, it will be understood that trash (H) such as fur staying on the floor surface (G) is adhered to the adhesive member 121 and then rotated together with the main brush 120 to approach the sub-brush 130.

The sub-brush 130 includes a sub-outer circumferential surface 131 and a sub-rotation shaft 132.

The sub-outer circumferential surface 131 defines an outer circumferential surface of the sub-brush 130. The sub-outer circumferential surface 131 is disposed to extend in a direction in which the sub-brush 130 extends, in a left-right direction in the illustrated embodiment. In other words, the sub-outer circumferential surface 131 may be defined as a side surface of the sub-brush 130.

The sub-outer circumferential surface 131 may have a low roughness. This is to remove trash (H) such as fur adhered to the adhesive member 121 using a roller method, but to prevent being adhered again to the sub-outer circumferential surface 131.

Trash (H) such as fur adhered to the adhesive member 121 may be pushed by the sub-brush 130 to be separated and removed from the adhesive member 121. The detailed description thereof will be described later.

The sub-brush 130 is rotated about the sub-rotation shaft 132. In other words, the sub-rotation shaft 132 is a portion in which the sub-brush 130 is rotatably coupled to the frame 110 (i.e., the side frame 112).

Thus, the sub-rotation shaft 132 may be referred to as a sub-support shaft.

The sub-rotation shaft 132 is disposed to extend in a direction in which the sub-brush 130 extends, in a left-right direction in the illustrated embodiment. The sub-rotation shaft 132 may be disposed to pass through a central axis of the cross section of the sub-brush 130.

In an embodiment in which the sub-brush 130 includes the first sub-brush 130a and the second sub-brush 130b, the sub-outer circumferential surface 131 and the sub-rotation shaft 132 are provided in the sub-brushes 130a, 130b, respectively.

In other words, the first sub-brush 130a may be provided with a first sub-outer circumferential surface 131a and a first sub-rotation shaft 132a. In addition, the second sub-brush 130b may be provided with a second sub-outer circumferential surface 131b and a second sub-rotation shaft 132b.

The gear part 140 transmits the rotation of the power part 150 to the sub-brush 130. Accordingly, both the main brush 120 and the sub-brush 130 may be rotated by a single power part 150. In addition, by the gear part 140, the main brush 120 and the sub-brush 130 may be rotated at different speeds.

The gear part 140 is connected to the power part 150. When the power part 150 is operated, the gear part 140 may be rotated.

Specifically, the gear part 140 may be coupled to the main brush 120 connected to the power oart 150 to rotate together with the main brush 120.

A plurality of gear parts 140 may be provided. In the illustrated embodiment, the gear part 140 includes a main gear 141 coupled to the main brush 120 and a sub-gear 142 coupled to the sub-brush 130.

The main gear 141 is coupled to the main brush 120. The main gear 141 may be rotated together with the main brush 120. In the illustrated embodiment, the main gear 141 is disposed to protrude radially outward from an outer circumference of the main brush 120. The main gear 141 may be disposed to surround an outer circumference of the main brush 120.

The main gear 141 may be provided in any form capable of being gear-fitted to the sub-gear 142.

A plurality of main gears 141 may be provided. The plurality of main gears 141 may be coupled to the main brushes 120 at different positions in a direction in which the main brushes 120 extend, and rotated together with the main brushes 120.

In the illustrated embodiment, the main gear 141 includes a first main gear 411a located on the left side and a second main gear 411b located on the right side. The first main gear 411a is coupled to a left end portion of the main brush 120. The second main gear 411b is coupled to a right end portion of the main brush 120.

The main gear 141 may include a plurality of teeth parts. In other words, the main gear 141 may include a plurality of concave portions and a plurality of convex portions that are alternately arranged with each other along an outer circumference thereof.

At this time, the number of the plurality of concave portions and the plurality of convex portions provided in the main gear 141 may be greater than that of the plurality of concave portions and the plurality of convex portions provided in the sub-gear 142.

Accordingly, when the power part 150 rotates, the main gear 141 rotates slower than the sub-gear 142. In other words, for a predetermined time period, the number of rotations of the main gear 141 is less than that of the sub-gear 142.

Accordingly, when the power part 150 rotates, the main brush 120 connected to the main gear 141 rotates slower than the sub-brush 130 connected to the sub-gear 142.

The sub-gear 142 is gear-coupled to the main gear 141. When the main gear 141 rotates, the sub-gear 142 gear-coupled to the main gear 141 also rotates. At this time, the sub-gear 142 rotates in a direction opposite to the rotation direction of the main gear 141.

In addition, as described above, the rotation speed of the sub-gear 142 is faster than that of the main gear 141.

The sub-gear 142 may be provided in any form capable of being gear-coupled to the main gear 141.

The sub-gear 142 may be provided at a plurality of positions. In each position, the sub-gear 142 may be gear-coupled to each main gear 141.

In the illustrated embodiment, the sub-gear 142 is provided at left and the right ends of the sub-brush 130, respectively. Each sub-gear 142 is gear-coupled to the first main gear 141a and the second main gear 141b, respectively.

A plurality of sub-gears 142 may be provided. The plurality of sub-gears 142 may be gear-coupled to the first main gear 141a and the second main gear 142a, respectively. In other words, a plurality of sub-gears 142 are gear-coupled to the first main gear 141a. Likewise, the plurality of sub-gears 142 are gear-coupled to the second main gear 141b.

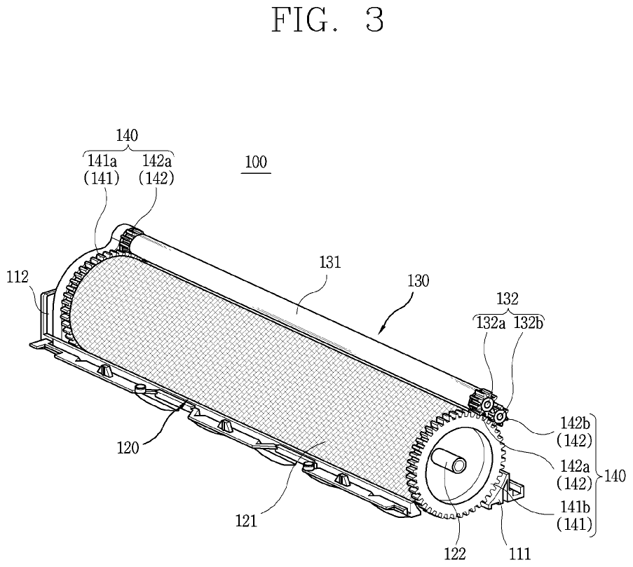

In an embodiment illustrated in FIGS. 3 through 6, the sub-gear 142 includes a first sub-gear 142a and a second sub-gear 142b. The first sub-gears 142a are located at respective end portions in a direction in which the first sub-brush 130a extends.

In other words, a plurality of first sub-gears 142a are provided. The plurality of first sub-gears 142a are gear-coupled to the first main gear 141a and the second main gear 141b, respectively.

The second sub-gears 142b are located at respective end portions in a direction in which the second sub brush 130b extends.

In other words, a plurality of second sub-gears 142b are provided. The plurality of second sub-gears 142b are gear-coupled to the first main gear 141a and the second main gear 141b, respectively.

In other words, it will be understood that the plurality of sub-gears 142 are provided in an embodiment in which the plurality of sub-brushes 130 are provided.

The sub-gear 142 may include a plurality of teeth parts. In other words, the sub-gear 142 may include a plurality of concave portions and a plurality of convex portions alternately arranged with each other along an outer circumference thereof.

At this time, the number of the plurality of concave portions and the plurality of convex portions provided in the sub-gear 142 may be less than that of the plurality of concave portions and the plurality of convex portions provided in the main gear 141.

In addition, as described above, accordingly, the rotation speed of the sub-gear 142 is defined faster than the rotation speed of the main gear 141.

The power part 150 generates power for rotating the main brush 120 and the sub-brush 130. The power part 150 is connected to the main gear 141 of the gear part 140. The power part 150 and the main gear 141 may rotate together.

The power part 150 may be provided in any form in which rotation or non-rotation thereof, a rotation direction, and a rotation speed, and the like can be controlled by an input of an electrical signal. In one embodiment, the power part 150 may be provided with an electric motor.

The power part 150 is electrically connected to an external power source (not shown) and a controller (not shown). Power for operating the power part 150 may be supplied from the power source (not shown). In addition, a control signal for controlling the rotation or non-rotation, the rotation direction, and the rotation speed, and the like of the power part 150 may be applied from the controller (not shown).

The power part 150 is connected to the main brush 120. When the power part 150 is operated, the main brush 120 may be rotated. Accordingly, the main gear 141 coupled to the main brush 120 may also rotate. As a result, the sub-gear 142 coupled to the main gear 141 and the sub-brush 130 coupled thereto may also be rotated.

The power part 150 may be located adjacent to either one of the first main gear 141a and the second main gear 141b. In the illustrated embodiment, a singular number of the power part 150 is provided and located adjacent to the second main gear 141b located on the right side.

The power part 150 may be coupled to the side frame 112 of the frame 110. Accordingly, the power part 150 may be stably supported.

The detailed description of a process of rotating the main brush 120 and the sub-brush 130 as the power part 150 is operated will be described later.

Description of nozzle part 200 according to another embodiment of present disclosure

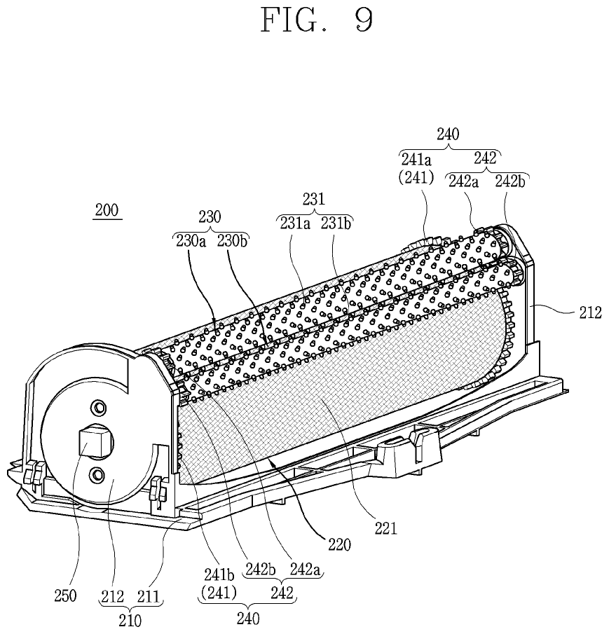

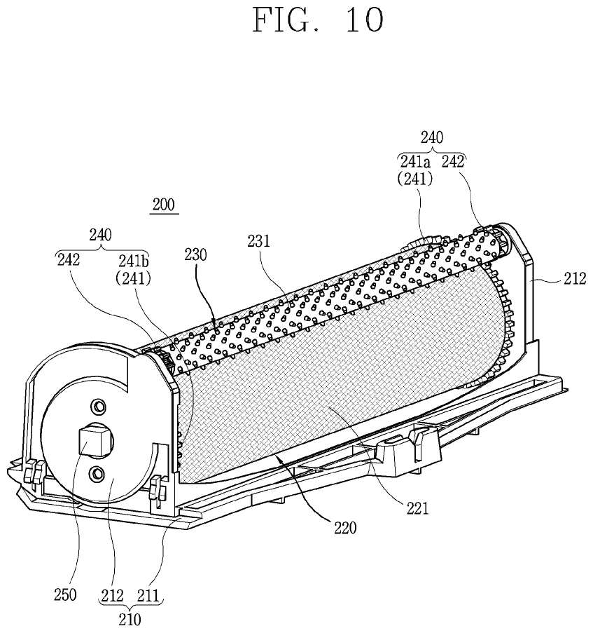

Hereinafter, a nozzle part 200 according to another embodiment of the present disclosure and a modified example thereof will be described in detail with reference to FIGS. 9 through 10.

In the illustrated embodiment, the nozzle part 200 includes a frame 210, a main brush 220, a sub-brush 230, a gear part 240, and a power part 250.

The nozzle part 200 according to the present embodiment differs from the nozzle part 100 according to the foregoing embodiment in the structure and shape of the sub-brush 230.

In other words, the frame 210, the main brush 220, the gear part 240, and the power part 250 of the nozzle part 200 according to the present embodiment are the same as the frame 110, the main brush 120, the gear part 140, and the power part 150 of the nozzle part 100 in the structure, function and effect thereof.

Accordingly, the description of the frame 210, the main brush 220, the gear part 240, and the power part 250 will be replaced with the description of the frame 110, the main brush 120, and the gear part 140, and the power part 150 according to the foregoing embodiment.

In addition, in the following description, the nozzle part 200 according to the present embodiment will be described in detail around the sub-brush 230 according to the present embodiment.

The sub-brush 230 separates trash adhered to the adhesive member 221 of the main brush 220, particularly, trash (H) such as fur from the adhesive member 221. The separated adhesive member 221 may be removed into the inside of the nozzle housing 50, and moved and collected into the dust bin 30 through the communication part 53.

The sub-brush 230 is located adjacent to the main brush 220. In the illustrated embodiment, the sub-brush 230 is located at an upper portion of the main brush 220.

The sub-brush 230 may be defined in a shape corresponding to the shape of an outer circumference of the main brush 220. In the illustrated embodiment, the main brush 220 has a cylindrical shape having a circular cross section, and the sub-brush 230 may also be formed in a cylindrical shape having a circular cross section.

At this time, a diameter of the cross section of the sub-brush 230 may be smaller than that of the cross section of the main brush 220. Accordingly, the rotational speeds of the sub-brush 230 and the main brush 220 may be adjusted.

The sub-brush 230 is located at a radial outer side of the main brush 220.

The sub-brush 230 may extend in the same direction as the main brush 220, in a left-right direction in the illustrated embodiment. The sub-brush 230 may have both end portions in an extending direction thereof, and left and right end portions in the illustrated embodiment, respectively, coupled to the support frame 212.

The sub-brush 230 may be formed of a lightweight and high rigid material. In one embodiment, the sub-brush 230 may be formed of a synthetic resin material such as reinforced plastic.

The sub-brush 230 may be rotated in a direction different from the rotation direction of the main brush 220. This is due to the fact that the sub-gear 242 coupled to the sub-brush 230 is gear-coupled to the main gear 241 coupled to the main brush 220.

Furthermore, a rotational speed of the sub-brush 230 may be faster than that of the main brush 220. Accordingly, the sub-brush 230 may quickly remove trash (H) such as fur collected by the main brush 220 from a radially outer side of the main brush 220.

This difference in speed is achieved by the gear part 240 as described above.

A plurality of sub-brushes 230 may be provided. In other words, in an embodiment illustrated in FIG. 9, two sub-brushes 230 including a first sub-brush 230a and a second sub-brush 230b are provided.

In the above embodiment, the first sub-brush 230a may be located above the second sub-brush 230b.

In addition, in an embodiment illustrated in FIG. 10, a singular number of the sub-brush 230 is provided.

In the above embodiments, the sub-brush 230 is located at a downstream side of the main brush 220. Accordingly, it will be understood that trash (H) such as fur staying on the floor surface (G) is adhered to the adhesive member 221 and then rotated together with the main brush 220 to approach the sub-brush 230.

The sub-brush 230 includes a protrusion member 231.

The protrusion member 231 separates trash (H) such as fur adhered to the adhesive member 221 of the main brush 220. The protrusion member 231 is formed on an outer circumference of the sub-brush 230.

The protrusion member 231 is disposed to protrude toward a radial outer side from the outer circumference of the sub-brush 230. In the illustrated embodiment, the protrusion member 231 has a shape of a truncated cone whose radius decreases in a direction opposite to the outer circumference of the sub-brush 230.

Alternatively, the shape of the protrusion member 231 may be defined to have the same cross-sectional area from the outer circumference of the sub-brush 230 toward the radial outer side. In another embodiment, the shape of the protrusion member 231 may have a shape of a truncated pyramid whose radius decreases from the outer circumference of the sub-brush 230 toward the radial outer side.

A plurality of protrusion members 231 may be provided. The plurality of protrusion members 231 may be spaced apart from each other, and disposed in parallel in a direction in which the sub-brush 230 extends, and in a left-right direction in the illustrated embodiment.

The protrusion members 231 may be arranged along a plurality of rows. Specifically, in the illustrated embodiment, the protrusion members 231 may be spaced apart from each other along a circumferential direction of the sub-brush 230 and arranged in parallel to each other.

In other words, in case where the set of any one of the protrusion members 231 arranged in parallel in a direction in which the sub-brush 230 extends is referred to as a row, each row is disposed to be spaced apart from each other in a circumferential direction on an outer circumferential surface of the sub-brush 230.

At this time, the protrusion members 231 arranged in adjacent rows to each other may be alternately arranged in a circumferential direction. In other words, a space in which the protrusion members 231 are not disposed is located adjacent to the protrusion member 231 located in any one row in a circumferential direction thereto.

Accordingly, the trash (H) such as fur adhered to the adhesive member 221 may be efficiently separated by the protrusion members 231 and a space defined between the protrusion members 231.

The protrusion members 231 may be provided on each of the sub-brushes 230a, 230b. In other words, the protrusion member 231 includes first protrusion members 231a arranged on the first sub-brush 230a and second protrusion members 231b arranged on the second sub-brush 230b.

In an embodiment in which the sub-brush 230 includes the first sub-brush 230a and the second sub-brush 230b, the first protrusion members 231a and the second protrusion members 231b may be arranged to engage with each other.

Specifically, the first sub-brush 230a and the second sub-brush 230b are disposed adjacent to each other.

When the first sub-brush 230a and the second sub-brush 230b are rotated, the first protrusion members 231a may be inserted into a space disposed between the second protrusion members 231b. Likewise, the second protrusion members 231b may be inserted into a space disposed between the first protrusion members 231a.

Accordingly, the first protrusion members 231a and the second protrusion members 231b may not affect the rotation of each of the sub-brushes 230a, 230b. Accordingly, each of the sub-brushes 230a, 230b is efficiently rotated, and trash (H) such as fur adhered to the adhesive member 321 may be effectively separated.

Description of nozzle part 300 according to still another embodiment of present disclosure

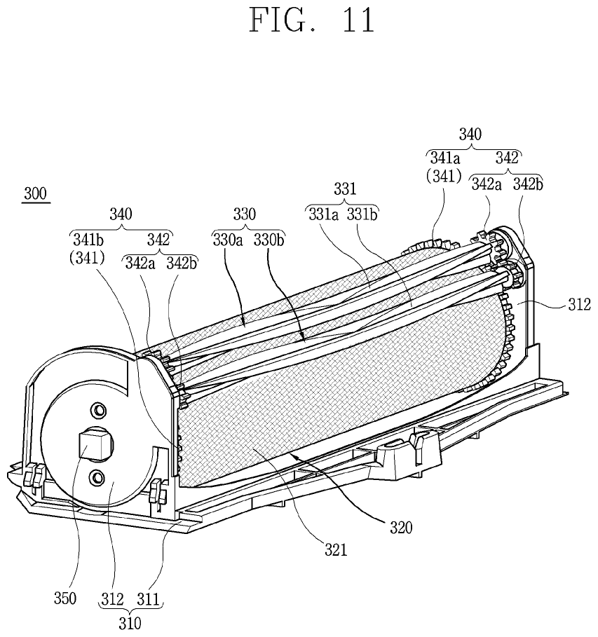

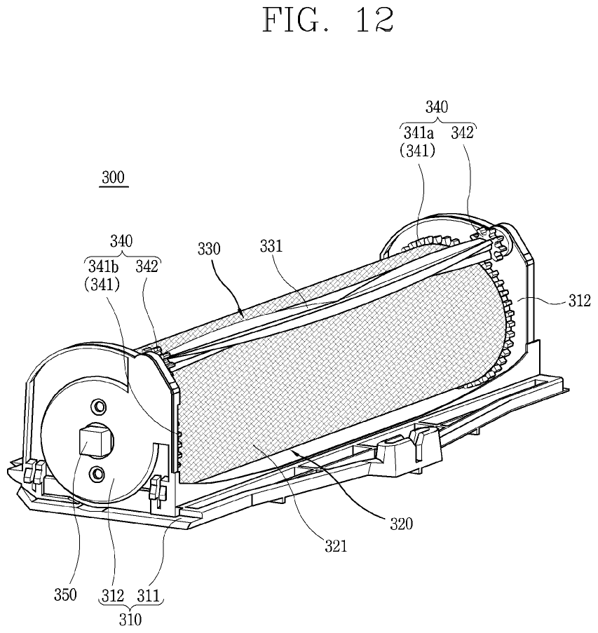

Hereinafter, a nozzle part 300 according to still another embodiment of the present disclosure and a modified example thereof will be described through detail with reference to FIGS. 11 through 12.

In the illustrated embodiment, the nozzle part 300 includes a frame 310, a main brush 320, a sub-brush 330, a gear part 340, and a power part 350.

The nozzle part 300 according to the present embodiment differs from the nozzle part 100, 200 according to the foregoing embodiment in the structure and shape of the sub-brush 330.

In other words, the frame 310, the main brush 320, the gear part 340, and the power part 350 of the nozzle part 300 according to the present embodiment are the same as the frame 110, 210, the main brush 120, 220, the gear part 140, 240, and the power part 150, 250 of the nozzle part 100 in the structure, function and effect thereof.

Accordingly, the description of the frame 310, the main brush 320, the gear part 340, and the power part 350 will be replaced with the description of the frame 110, 210, the main brush 120, 220, and the gear part 140, 240, and the power part 150, 250 according to the foregoing embodiment.

In addition, in the following description, the nozzle part 300 according to the present embodiment will be described in detail around the sub-brush 330 according to the present embodiment.

The sub-brush 330 separates trash adhered to the adhesive member 321 of the main brush 320, particularly, trash (H) such as fur from the adhesive member 321. The separated adhesive member 321 may be removed into the inside of the nozzle housing 50, and moved and collected into the dust bin 30 through the communication part 53.

The sub-brush 330 is located adjacent to the main brush 320. In the illustrated embodiment, the sub-brush 330 is located at an upper portion of the main brush 320.

The sub-brush 330 may be defined in a shape corresponding to the shape of an outer circumference of the main brush 320. In the illustrated embodiment, the main brush 320 has a cylindrical shape having a circular cross section, and the sub-brush 330 may also be formed in a cylindrical shape having a circular cross section.

However, a cross-section of the sub-brush 330 according to the present embodiment may be defined in a circular shape having a virtual cross-section extending its outer circumference other than a completely circular shape.

At this time, a diameter of the cross section of the sub-brush 330 may be smaller than that of the cross section of the main brush 320. Accordingly, the rotational speeds of the sub-brush 330 and the main brush 320 may be adjusted.

The sub-brush 330 is located at a radial outer side of the main brush 320.

The sub-brush 330 may extend in the same direction as the main brush 320, in a left-right direction in the illustrated embodiment. The sub-brush 330 may have both end portions in an extending direction thereof, and left and right end portions in the illustrated embodiment, respectively, coupled to the support frame 312.

The sub-brush 330 may be formed of a lightweight and high rigid material. In one embodiment, the sub-brush 330 may be formed of a synthetic resin material such as reinforced plastic.

The sub-brush 330 may be rotated in a direction different from the rotation direction of the main brush 320. This is due to the fact that the sub-gear 342 coupled to the sub-brush 330 is gear-coupled to the main gear 341 coupled to the main brush 320.

Furthermore, a rotational speed of the sub-brush 330 may be faster than that of the main brush 320. Accordingly, the sub-brush 330 may quickly remove trash (H) such as fur collected by the main brush 320 from a radially outer side of the main brush 320.

This difference in speed is achieved by the gear part 340 as described above.

A plurality of sub-brushes 330 may be provided. In other words, in an embodiment illustrated in FIG. 11, two sub-brushes 330 including a first sub-brush 330a and a second sub-brush 330b are provided.

In the above embodiment, the first sub-brush 330a may be located above the second sub-brush 330b.

In addition, in an embodiment illustrated in FIG. 12, a singular number of the sub-brush 330 is provided.

In the above embodiments, the sub-brush 330 is located at a downstream side of the main brush 320. Accordingly, it will be understood that trash (H) such as fur staying on the floor surface (G) is adhered to the adhesive member 321 and then rotated together with the main brush 320 to approach the sub-brush 330.

In the illustrated embodiment, the sub-brush 330 includes a blade member 331.

The blade member 331 separates trash (H) such as fur adhered to the adhesive member 321 of the main brush 320. The blade member 331 is defined on an outer circumference of the sub-brush 330.

The blade member 331 defines an outer circumference of the sub-brush 330. In other words, the sub-brush 330 may be configured by connecting a plurality of blade members 331 to each other.

The blade member 331 extends in a direction in which the sub-brush 330 extends, in a left-right direction in the illustrated embodiment. Each end portion in a direction in which the blade member 331 extends, each end portion on the left and right sides in the illustrated embodiment may be connected to the sub-gear 342.

When the direction in which the blade members 331 extends, that is, the left-right direction in the illustrated embodiment, is defined as a length direction, a direction in which the blade member 331 extends toward each other may be defined as a width direction.

Either one end portions of the blade member 331 in a width direction facing each other may be connected to each other. In addition, the other end portions of the blade member 331 in a width direction opposite to each other may define an outer circumference of the sub-brush 330.

The blade member 331 may extend to define a curve. In other words, the blade member 331 includes at least one curved portion in the length direction. Accordingly, a surface area of the blade member 331 may increase to effectively separate trash (H) such as fur adhered to the adhesive member 321.

A plurality of blade members 331 may be provided. The plurality of blade members 331 may define respective sub-brushes 330a, 330b.

In other words, the blade member 331 includes a plurality of first blade members 331a defining a first sub-brush 330a and a plurality of second blade members 331b defining a second sub-brush 330b.

In an embodiment in which the sub-brush 330 includes the first sub-brush 330a and the second sub-brush 330b, the first blade members 331a and the second blade members 331b may be arranged to engage with each other.

Specifically, the first sub-brush 330a and the second sub-brush 330b are disposed adjacent to each other.

When the first sub-brush 330a and the second sub-brush 330b are rotated, the first blade members 331a may be inserted into a space disposed between the second blade members 331b. Likewise, the second blade members 331b may be inserted into a space formed between the plurality of first blade members 331a.

Accordingly, the first blade members 331a and the second blade members 331b may not affect the rotation of each of the sub-brushes 330a, 330b. Accordingly, each of the sub-brushes 330a, 330b is efficiently rotated, and trash (H) such as fur adhered to the adhesive member 321 may be effectively separated.

4. Description of operation process of nozzle part 100, 200, 300 according to an embodiment of the present disclosure and robot cleaner 1 including the same

The nozzle part 100, 200, 300 according to various embodiments of the present disclosure and the robot cleaner 1 including same may effectively collect trash (H) such as fur staying in the driving environment.

In addition, the collected trash (H) such as fur may be easily separated and accommodated in the dust bin 30, even when the user does not perform an additional operation.

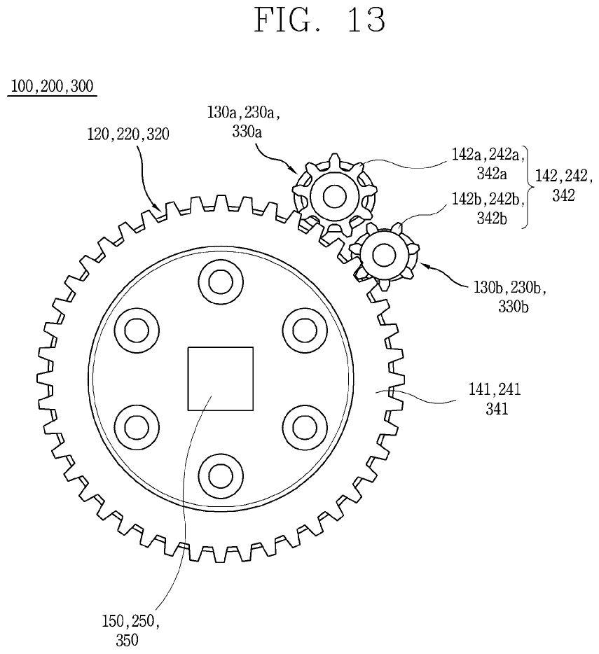

Hereinafter, with reference to FIGS. 13 through 15, a process in which trash (H) such as fur is collected and separated by the nozzle part 100, 200, 300 according to various embodiments of the present disclosure and the robot cleaner 1 including the same will be described in detail.

Referring to FIG. 13, an example of each gear part 140, 240, 340 of the nozzle part 100, 200, 300 according to various embodiments of the present disclosure is illustrated. In the illustrated embodiment, it will be understood that a plurality of respective sub-brushes 130, 230, 330 are provided.

When the power part 150, 250, 350 is operated to rotate the main gear 141, 241, 341, each sub-gear 142, 242, 342 is also rotated. At this time, it will be understood that the rotation direction of each sub-gear 142, 242, 342 is rotated in a direction opposite to that of the main gear 141, 241, 341.

Accordingly, the main brush 120, 220, 320 coupled to the main gears 141, 241, 341 and the sub-brush 130, 230, 330 coupled to the sub-gear 142, 242, 342 are also rotated together.

Accordingly, trash (H) such as fur adhered to the adhesive member 121, 221, 321 is rotated together with the main brush 120, 220, 320 to enter between the sub-brushes 130, 230, 330. At this time, each of the sub-brushes 130, 230, 330 includes a member for separating trash (H) such as fur.

Accordingly, trash (H) such as fur is separated and removed from the main brush 120, 220, 320. The removed trash (H) such as fur is introduced into the dust bin 30 through an inner space of the nozzle housing 50 and an inner space of the body part 10.

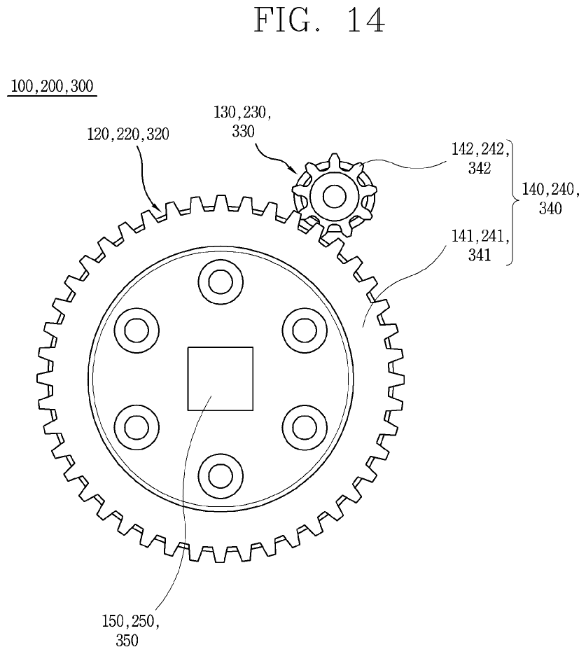

Referring to FIG. 14, a modified example of each gear part 140, 240, 340 of the nozzle part 100, 200, 300 according to various embodiments of the present disclosure is illustrated. In the illustrated embodiment, it will be understood that each sub-brush 130, 230, 330 is provided in a single number.

When the power part 150, 250, 350 is operated to rotate the main gear 141, 241, 341, each sub-gear 142, 242, 342 is also rotated. At this time, it will be understood that the rotation direction of each sub-gear 142, 242, 342 is rotated in a direction opposite to that of the main gear 141, 241, 341.

Accordingly, the main brush 120, 220, 320 coupled to the main gears 141, 241, 341 and the sub-brush 130, 230, 330 coupled to the sub-gear 142, 242, 342 are also rotated together.

Accordingly, trash (H) such as fur adhered to the adhesive member 121, 221, 321 is rotated together with the main brush 120, 220, 320 to enter between the sub-brush 130, 230, 330 and the main brush 120, 220, 320. At this time, each of the sub-brushes 130, 230, 330 includes a member for separating trash (H) such as fur.

Accordingly, trash (H) such as fur is separated and removed from the main brush 120, 220, 320. The removed trash (H) such as fur is introduced into the dust bin 30 through an inner space of the nozzle housing 50 and an inner space of the body part 10.

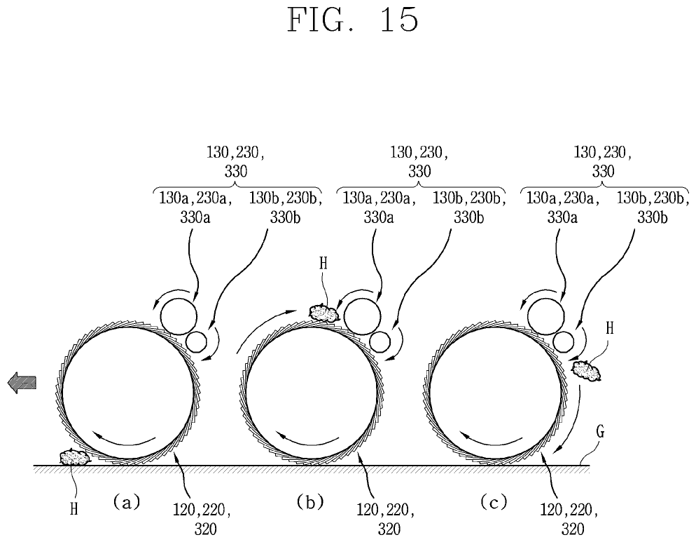

Referring to FIG. 15, a process in which trash (H) such as fur is collected and separated by the nozzle part 100, 200, 300 according to various embodiments of the present disclosure and the robot cleaner 1 including the same is illustrated as a conceptual view.

Referring to (a) of FIG. 15, the main brush 120, 220, 320 and the sub-brush 130, 230, 330 of each nozzle part 100, 200, 300 provided in the robot cleaner 1 driven on the floor surface (G) toward the left side are illustrated.

At this time, it will be understood that the sub-brush 130, 230, 330 is rotated according to the operation of the power part 150, 250, 350, but rotated at a faster speed than the main brush 120, 220, 320 in a direction opposite to the main brush 120, 220, 320.

Here, trash (H) such as fur is located on the floor surface (G) before the robot cleaner (1) passes therethrough.

Referring to (b) of FIG. 15, it is illustrated a state in which the robot cleaner 1 is driven and trash (H) such as fur existing on the floor surface (G) is collected by the main brush 120, 220, 320.

As described above, the main brush 120, 220, 320 includes an adhesive member 121, 221, 321 that surrounding an outer circumference thereof. The adhesive member 121, 221, 321 may be formed of a fiber material having a high roughness such as felt.

As the rotation of the main brush 120, 220, 320 continues, trash (H) such as fur adhered to the adhesive member 121, 221, 321 is rotated in a clockwise direction inside the frame 110, 210, 310, that is, in the illustrated embodiment.

Referring to (c) of FIG. 15, it is illustrated a state in which trash (H) such as fur adhered to the adhesive member 121, 221, 221 is removed by each removal member 130, 230, 330.

In other words, trash (H) such as fur that has entered between the sub-brushes 130, 230, 330 by the rotation of the main brush 120, 220, 320 is separated from the adhesive member 121, 221, 321 by the sub-brushes 130, 230, 330 rotated in a direction opposite to the main brush 120.

A plurality of sub-brushes 130, 230, 330 may be provided in the illustrated embodiment, but a single number of sub-brush 130, 230, 330 may be provided as in the foregoing modified example. In the above embodiment, it will be understood that the adhered trash (H) such as fur enters between the main brush 120, 220, 320 and the sub-brush 130, 230, 330, and is separated by the sub-brush 130, 230, 330.

As described above, the inner space of the nozzle housing 50 communicates with an inner space of the body part 10 and the dust bin 30 through the communication part 53.

Accordingly, the removed trash (H) such as fur is collected in the dust bin 30 through the communication part 53 and the inner space of the body part 10.

As a result, the nozzle part 100, 200, 300 according to an embodiment of the present disclosure and the robot cleaner 1 including the same may effectively collect trash (H) such as fur that is difficult to remove from the floor surface (G).

In addition, the collected trash (H) such as fur may be easily separated from the main brush 120, 220, 320 by the sub-brush 130, 230, 330 and accommodated in the dust bin 30.

Moreover, the above process may be achieved by rotating the main brush 120, 220, 320 and the sub-brush 130, 230, 330 at different speeds by a single number of the power part 600.

Though the present invention is described with reference to preferred embodiments, various modifications and improvements will become apparent to those skilled in the art without departing from the concept and scope of the present invention as defined in the following claims.
1: Robot cleaner
10: Body part
20: Driving part
30: Dust bin
40: Sensor part
50: Nozzle housing
51: Outer housing
52: Inner housing
53: Communication part
100: Nozzle part according to an embodiment of the present disclosure
110: Frame
111: Lower frame
112: Side frame
120: Main brush
121: Adhesive member
122: Main rotation shaft
130: Sub-brush
130a: First sub-brush
130b: Second sub-brush
131: Sub-outer circumferential surface
131a: First sub-outer circumferential surface
131b: Second sub-outer circumferential surface
132: Sub-rotation shaft
132a: First sub-rotation shaft
132b: Second sub-rotation shaft
140: gear part
141: Main gear
141a: First main gear
141b: Second main gear
142: Sub-gear
142a: First sub-gear
142b: Second sub-gear
150: Power part
200: Nozzle part according to another embodiment of the present
disclosure
210: Frame
211: Lower frame
212: Side frame
220: Main brush
221: Adhesive member
230: Sub-brush
230a: First sub-brush
230b: Second sub-brush
231: Protrusion member
231a: First protrusion member
231b: Second protrusion member
240: Gear part
241: Main gear
241a: First main gear
241b: Second main gear
242: Sub-gear
242a: First sub-gear
242b: Second sub-gear
250: Power part
300: Nozzle part according to still another embodiment of the present
disclosure
310: Frame
311: Lower frame
312: Side frame
320: Main brush
321: Adhesive member
330: Sub-brush
330a: First sub-brush
330b: Second sub-brush
331: Blade member
331a: First blade member
331b: Second blade member
340: Gear part
341: Main gear
341a: First main gear
341b: Second main gear
342: Sub-gear
342a: First sub-gear
342b: Second sub-gear
350: Power part
H: Trash such as fur
G: Floor surface

1. A nozzle assembly, comprising:
a frame;
a main roller rotatably coupled to the frame to extend in an extension direction; and
a sub-roller located adjacent to the main roller brush to extend in the extension direction, and rotatably coupled to the frame
wherein;
the main roller includes an adhesive surface provided at an outer circumference of the main roller,
the sub-roller, is located at a downstream side of a rotation direction of the main roller such that a rotation of the main roller causes an object that is adhered to the adhesive surface to be moved by a predetermined distance in the rotation direction of the main roller, and then brought into contact with the sub-roller, and
the main roller and the sub-roller are rotated in opposite directions.

2. The nozzle assembly of claim 1, wherein an outer circumference of the sub-roller has a roughness less than that of the adhesive surface.

3. The nozzle assembly of claim 2, wherein:
the nozzle assembly comprises a plurality of the sub-roller,
the plurality of sub-rollers are located adjacent to each other, and
the object is separated from the adhesive surface while passing between a pair of the plurality of sub-rollers.

4. The nozzle assembly of claim 1, wherein the sub-roller comprises:
a protrusion extending from an outer circumferential surface of the sub-roller to separate the object from the adhesive surface.

5. The nozzle assembly of claim 4, wherein:
the sub-roller includes a plurality of the protrusions and the plurality of the protrusions are spaced apart from each other and arranged in parallel along an axial direction of the sub-roller, and
a plurality of rows are defined by arranging the plurality of the protrusions in parallel along the axial direction of the sub-roller and to be spaced apart from each other along a circumferential direction of the sub-roller.

6. The nozzle assembly of claim 5, wherein for the respective rows located adjacent to each other among the rows defined by the plurality of protrusions, the protrusions and spaces between the protrusions are alternately arranged along the circumferential direction of the sub-roller.

7. The nozzle assembly of claim 5, wherein:
the nozzle assembly includes a plurality of the sub-rollers,
the plurality of the sub-rollers are located adjacent to each other, and
ones of the protrusions provided on one of the plurality of the sub-rollers are inserted into spaces between other ones of the protrusions provided on another one of the plurality of sub-rollers.

8. The nozzle assembly of claim 4, wherein a cross-sectional area of the protrusion is defined to be reduced in a direction opposite to the an outer circumferential direction of the sub-roller.

9. The nozzle assembly of claim 1, wherein the sub-roller comprises:
a plurality of blades extending in the extension direction of the sub-roller, radially inward end portions of the plurality of blades being coupled to each other, and radially outward end portions of the plurality of blades being externally exposed.

10. The nozzle assembly of claim 9, wherein one of the blades includes:
at least one curved portion along the extension direction of the sub-roller.

11. The nozzle assembly of claim 1, further comprising:
a main gear coupled to the main roller to rotate together with the main roller; and
a sub-gear coupled to the sub-roller, and gear-fitted to the main gear.

12. The nozzle assembly of claim 11, wherein:
the main gear comprises a larger number of gear teeth than the sub-gear.

13. A robot cleaner, comprising:
a body;
a dust bin detachably coupled to the body part, and having a space defined therein;
a nozzle housing detachably coupled to the body, an inner space of the nozzle housing communicating with the space of the dust bin; and
a nozzle assembly accommodated in the nozzle housing, and exposed to an outside of the nozzle housing,
wherein the nozzle assembly comprises:
a frame coupled to the nozzle housing;
a main roller rotatably coupled to the frame to extend in an extension direction; and
a sub-roller located adjacent to the main roller, extending in the extension direction, and rotatably coupled to the frame,
wherein:
the main roller comprises an adhesive surface provided at an outer circumference of the main roller, and
the sub-roller is located at a downstream side of a rotation direction of the main roller such that an object adhered to the adhesive surface is moved by a predetermined distance in a rotation direction of the main roller, and then brought into contact with the sub-roller, and
the main roller and the sub-roller are rotated in opposite directions.

14. The robot cleaner of claim 13, further comprising:
a main gear coupled to the main roller to rotate together with the main roller;
a sub-gear coupled to the sub-roller to be rotated together with the sub-roller, and gear-coupled to the main gear; and
a motor to rotate the main roller,
wherein a number of teeth in the main gear is greater than a number of teeth in the sub-gear, and
the sub-roller is rotated at a faster speed than the main roller when the main roller is rotated by the motor.

15. The robot cleaner of claim 13, wherein:
the nozzle assembly includes a plurality of the sub-rollers,
each of the sub-rollers has an outer circumferential surface that is relatively smoother than the adhesive surface of the main roller,
the plurality of the sub-rollers are located adjacent to each other, and
the adhered object is separated from the adhesive surface while passing between a pair of the plurality of sub-rollers.

16. The robot cleaner of claim 13, comprising:
a protrusion extending from an outer circumferential surface of the sub-roller to separate the adhered object from the adhesive surface.

17. The robot cleaner of claim 13,
wherein the sub-roller includes a plurality of blades extending in an axial direction of the sub-roller, radially inward end portions of the blades being coupled to each other, and radially outward end portions of blades being externally exposed,
wherein one of the blades includes at least one curved portion along the extension direction of the sub-roller.

18. The nozzle assembly of claim 1, wherein the adhesive surface surrounds the outer circumference of the main roller.

19. The robot cleaner of claim 16, wherein the adhesive surface surrounds the outer circumference of the main roller.

20. The robot cleaner of claim 16, wherein:
the sub-roller includes a plurality of the protrusions, and the plurality of the protrusions are spaced apart from each other and arranged in parallel along an axial direction of the sub-roller, and
a plurality of rows are defined by arranging the plurality of the protrusions in parallel along the axial direction and to be spaced apart from each other along a circumferential direction of the sub-roller.
